(19) United States
(12) Patent Application Publication
(10) Pub. No.: US 2019/0368449 A1
(43) Pub. Date: Dec. 5, 2019

(54) RETURNLESS FUEL SYSTEM WITH ACCUMULATOR

(71) Applicant: GM GLOBAL TECHNOLOGY OPERATIONS LLC, Detroit, MI (US)

(72) Inventors: Dale F. Klein, Hartland, MI (US); Manoharan Thiagarajan, Milford, MI (US); William L. Villaire, Clarkston, MI (US); Edward J. Strzelecki, Oxford, MI (US)

(21) Appl. No.: 15/995,585

(22) Filed: Jun. 1, 2018

(51) Int. Cl. F02M 37/00; F02M 37/14; F02D 33/00; F02D 41/38; F02D 41/30

(52) U.S. Cl. CPC F02M 37/0058; F02M 37/0029; F02M 37/14; F02M 2037/087; F02D 41/3845; F02D 41/3082; F02M 2200/40; F02D 33/006

(57) ABSTRACT

A returnless fuel system includes a fuel injector, an accumulator, a first fuel pump assembly and a second fuel pump assembly. The accumulator is adapted to store pressurized fuel that is utilized by the fuel injector during prescribed conditions. The first fuel pump assembly is adapted to supply the pressurized fuel at a controlled pressure to the fuel injector. The second fuel pump assembly is in fluid communication with the accumulator and the first fuel pump assembly, and is adapted to provide the pressurized fuel at a controlled pressure to the first fuel pump assembly and the accumulator.

### INTRODUCTION

The subject disclosure relates a fuel system, and more particularly, to a returnless fuel system with a hydraulic accumulator.

Traditional fuel systems commonly found in vehicles propelled by internal combustion engines include a fuel pump module that may be located inside a fuel tank. The module typically has many components including an electronic returnless fuel system (ERFS) pump that acts as the primary device to supply fuel to a direct injection (DI) fuel pump at a specified feed fuel pressure. To meet the requirements of the DI fuel pump, the ERFS pump runs continuously producing a sustained electrical load. Continuous operation of the ERFS pump reduces fuel economy and may be detrimental toward hot fuel handling performance.

Accordingly, it is desirable to provide a more energy efficient fuel system.

### SUMMARY

In one exemplary embodiment, a returnless fuel system includes a fuel injector, an accumulator, a first fuel pump assembly, and a second fuel pump assembly. The accumulator is adapted to store pressurized fuel that is utilized by the fuel injector during prescribed conditions. The first fuel pump assembly is adapted to supply the pressurized fuel at a controlled pressure to the fuel injector. The second fuel pump assembly is in fluid communication with the accumulator and the first fuel pump assembly, and is adapted to provide the pressurized fuel at a controlled pressure to the first fuel pump assembly and the accumulator.

In addition to one or more of the features described herein, the returnless fuel system includes at least one pressure sensor, one or more non-transitory storage mediums, and one or more processors. The at least one pressure sensor is configured to measure accumulator fuel pressure (P_{acc}) upstream of the second fuel pump assembly and output a pressure signal. The one or more non-transistory storage mediums are configured to store a data file that includes a preprogrammed minimum first accumulator discharge pressure (P_{dis}). The one or more processors are configured to receive the pressure signal and compare the measured accumulator fuel pressure (P_{acc}) to the minimum first accumulator discharge pressure (P_{dis}), and maintain the second fuel pump assembly in an inactive state while the accumulator provides the pressurized fuel to the first fuel pump assembly if the measured accumulator fuel pressure (P_{acc}) is greater than or equal to the preprogrammed first minimum accumulator discharge pressure (P_{dis}).

In addition to one or more of the features described herein, the returnless fuel system includes a check valve located downstream of the second fuel pump assembly.

In addition to one or more of the features described herein, the returnless fuel system includes a solenoid valve adapted to isolate the accumulator during at least one of start-up and shut-down conditions.

In addition to one or more of the features described herein, the one or more processors are configured to effect the opening of the solenoid valve and activate the second fuel pump assembly to provide fuel to the accumulator during a deceleration fuel cut-off event, and when the measured accumulator fuel pressure (P_{acc}) is not greater than or equal to the preprogrammed first minimum accumulator discharge pressure (P_{dis}).

In addition to one or more of the features described herein, the one or more processors are configured to activate the second fuel pump assembly to at least provide fuel to the accumulator during a deceleration fuel cut-off event and when the measured accumulator fuel pressure (P_{acc}) isthan less the preprogrammed first minimum accumulator discharge pressure (P_{dis}).

In addition to one or more of the features described herein, the one or more processors are configured to deactivate the second fuel pump assembly when a preprogrammed second minimum accumulator discharge pressure (Pₘᵢₙ), stored in the data file, is less than or equal to the measured accumulator fuel pressure (P_{acc}), and the measured accumulator fuel pressure (P_{acc}) is less than the preprogrammed first minimum accumulator discharge pressure (P_{dis}).

In addition to one or more of the features described herein, the one or more processors are configured to effect activation of the second fuel pump assembly during the deceleration fuel cut-off event for supplying fuel to both the accumulator and the second fuel pump assembly when the measured accumulator fuel pressure (P_{acc}) is less than the preprogrammed second minimum accumulator discharge pressure (Pₘᵢₙ).

In addition to one or more of the features described herein, the one or more processors are configured to effect deactivation of the second fuel pump assembly during the deceleration fuel cut-off event when the measured accumulator fuel pressure (P_{acc}) exceeds the preprogrammed second minimum accumulator discharge pressure (Pₘᵢₙ) by a preprogrammed margin stored in the data file.

In addition to one or more of the features described herein, alternator regeneration provides electrical power to the second fuel pump assembly during the deceleration fuel cut-off event.

In addition to one or more of the features described herein, the returnless fuel system includes a fuel tank, with the accumulator located in the fuel tank.

In addition to one or more of the features described herein, the returnless fuel system includes a fuel conduit and a check valve. The fuel conduit is in communication with, and extends between, the first and second fuel pump assemblies. The check valve is adapted to prevent the backflow of pressurized fuel from the fuel conduit and through the second fuel pump assembly.

In another exemplary embodiment, a method of operating a returnless fuel system includes flowing fuel from a hydraulic accumulator to a direct injection (DI) fuel pump assembly. The fuel is then pumped by the DI fuel pump assembly to at least one fuel injector for combustion in a combustion engine. The hydraulic accumulator is recharged by an electric fuel feed pump assembly.

In addition to one or more of the features described herein, the electric fuel feed pump assembly is configured to recharge the hydraulic accumulator during deceleration fuel cut-off events.

In addition to one or more of the features described herein, the method includes opening a normally closed solenoid valve located proximate to an opening of the hydraulic accumulator when the hydraulic accumulator is flowing the fuel to the DI fuel pump assembly, and with the electric fuel feed pump assembly is recharging the hydraulic accumulator.

In addition to one or more of the features described herein, the hydraulic accumulator and the electric fuel feed pump assembly are located in a fuel tank of the fuel system.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic of a fuel system as one, non-limiting, embodiment of the present disclosure;

FIG. 2 is a flow chart of a method of operating the fuel system; and

FIG. 3 is a partial schematic of a second embodiment of the fuel system.

### DETAILED DESCRIPTION

The following description is merely exemplary in nature and is not intended to limit the present disclosure, its application or uses. For example, the present disclosure describes an electronic, retumless, fuel system having a direct injection (DI) pump for supplying fuel to a multitude of fuel injectors. The DI pump is adapted to receive fuel from either one or both of a fuel accumulator and a second pump depending upon prescribed fuel parameters. However, the fuel system may not be “retumless,” may not have the DI pump, and/or may not be adapted to supply fuel to the multitude of fuel injectors.

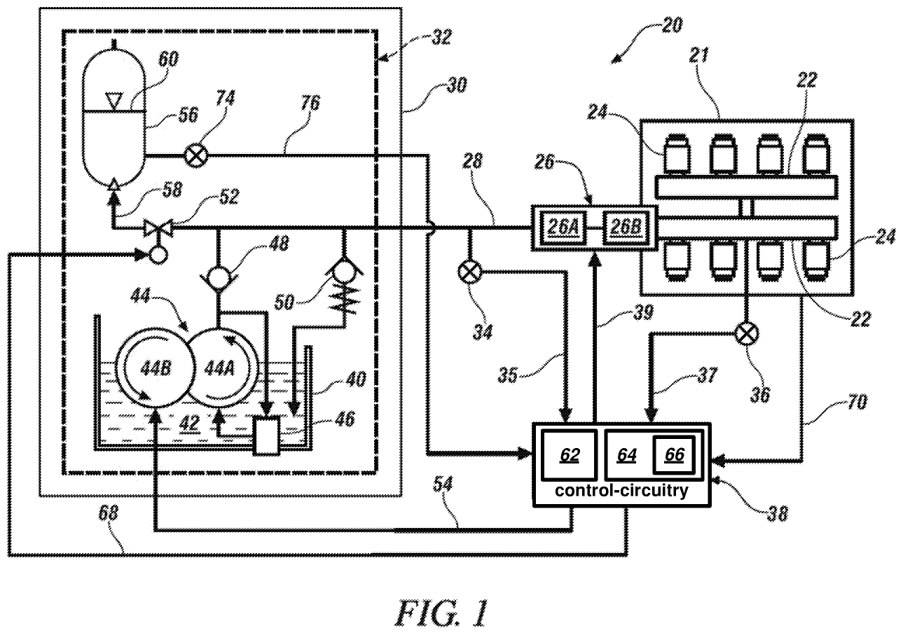

Referring to FIG. 1, and in accordance with an exemplary embodiment, a fuel system 20 is illustrated as an electronic and retumless fuel system. In one example, the fuel system 20 may be adapted to provide fuel at a controlled pressure to a combustion engine 21 of a vehicle (not shown). The fuel system 20 may include at least one fuel rail 22 (i.e., two illustrated), at least one fuel injector 24 (i.e., eight illustrated), a fuel pump assembly 26 (e.g., engine driven direct injection (DI) pump and/or a high pressure pump), a fuel line or conduit 28, a fuel tank 30, a fuel pump module 32 (e.g., feed pump module), at least one sensor (e.g., two pressure sensors illustrated as 34, 36), and a control-circuitry 38. The fuel pump module 32 may be located inside the fuel tank 30 and is adapted to supply fuel at a specified feed fuel pressure to the pump assembly 26 via the fuel line or conduit 28. The fuel pump assembly 26 is adapted to supply fuel to the fuel injector(s) 24 at a pressure that may be prescribed and controlled by the control-circuitry 38. It is understood that the fuel pump module 32 may be constructed to be inserted into the fuel tank 30, and supported by the fuel tank, as a single unit.

In one embodiment, the pressure sensor 34 (e.g., fuel feed pressure sensor) is located in the conduit 28 for measuring available conduit fuel pressure generally at an inlet of the fuel pump assembly 26. The pressure sensor 36 is located at the fuel rails 22 for measuring fuel pressure in the fuel rails 22. The sensors 34, 36 are configured to send respective pressure signals (see arrows 35, 37) to the control-circuitry 38 for at least control of the fuel pump assembly 26. In one embodiment, the fuel pump assembly 26 includes a mechanically driven positive displacement fuel pump 26A and an electric control solenoid and inlet valve 26B for controllably metering the fuel pump 26A fuel delivery volume via the control-circuitry 38. The control-circuitry 38 is configured to process at least the pressure signals 35, 37, and thereby output a control signal (see arrow 39) to the motor 26B. In another embodiment, the fuel pump assembly 26 may include a fuel pump 26A and an electric motor 26B for controllably driving the fuel pump 26A via the control-circuitry 38.

In one embodiment, the fuel pump module 32 includes a casing 40 that defines a fuel reservoir 42, a fuel pump assembly 44, a suction valve 46 (i.e., jet pump assembly), a check valve 48, an over pressure relief valve 50, a solenoid valve 52, and a hydraulic accumulator 56. The fuel pump assembly 44 may be disposed in the fuel reservoir 42. The accumulator 56 and an outlet of the fuel pump assembly 44 are in fluid communication with the conduit 28 for flowing fuel to an inlet of the fuel pump 26A. The suction valve 46 is adapted to draw fuel from the fuel tank 30 (i.e., external from the fuel reservoir 42), and to an inlet of the fuel pump assembly 44.

The check valve 48 is generally located between the outlet of the fuel pump assembly 44 and the conduit 28 to prevent the backflow of fuel (or the relief of fuel pressure) from the conduit 28 and through the pump assembly 44. The solenoid valve 52 may be in the conduit 28 and/or at a flow port or opening 58 of the accumulator 56 (i.e., between the flow opening 58 and an outlet of the check valve 48). The pressure relief valve 50 is adapted to relieve fuel pressure in the conduit 28. For example, trapped fuel in the conduit 28 when the combustion engine 21 may increase in pressure upon an increase in temperature causing fuel pressure to unintentionally increase until the relief valve 50 opens and flows a portion of fuel back to the reservoir 42.

The fuel pump assembly 44 includes a fuel pump 44A and an electric motor 44B for controllably driving the fuel pump 44A via the control-circuitry 38. Non-limiting examples of the motor 44B include a direct current (DC) brushed motor, and a three phase brushless motor. The control-circuitry 38 is configured to output a control signal (see arrow 54) to control operation of the motor 44B.

The hydraulic accumulator 56 is adapted to receive fuel from the fuel pump assembly 44 via the opening 58, and expel fuel through the opening 58 when drawn by the fuel pump assembly 26. The hydraulic accumulator 56 may further include a bladder 60 for the storage of fuel within the accumulator 56 at a pre-established pressure, as is known in the art of liquid accumulators. Although illustrated as part of the fuel pump module 32, the hydraulic accumulator 56 may be located in the fuel tank 30 but not part of the module 32, or the hydraulic accumulator 56 may be located outside of the fuel tank 30 and immediately upstream of the fuel pump assembly 26 (i.e., proximate to the inlet of the fuel pump 26A).

The control-circuitry 38 of the fuel system 20 includes one or more processors 62 and one or more electronic storage mediums 64 (e.g., non-transitory storage medium). The processor 62 is any combination of one or more of a central processing unit (CPU), multiprocessor, microcontroller unit (MCU), digital signal processor (DSP), application specific integrated circuit, and others capable of executing software instructions or otherwise controllable to behave according to predetermined logic. The storage medium 64 is, optionally, any combination of read and write memory (RAM) and read only memory (ROM). The storage medium 64 may also include persistent storage, which can be any single one or combination of solid state memory, magnetic memory, or optical memory storing a computer program (i.e., application) with software instructions.

In operation, the pump 44A of the pump assembly 44 is generally the primary device used to supply fuel to the DI pump 26A of the pump assembly 26 at a specified feed fuel pressure that may be preprogrammed and stored as part of a data file 66 in the storage medium 64 of the control-circuitry 38. The hydraulic accumulator 56 and coordinated control of the pump 44A by the control-circuitry 38, effects the storage of pressurized fuel in the hydraulic accumulator 56 during deceleration fuel cut-off events of the vehicle. Later fuel demand by the running combustion engine 21 causes fuel to be drawn from the accumulator 56, instead of requiring operation of pump assembly 44. This fuel draw from the accumulator 56 reduces, or eliminates the electrical load that would otherwise be needed for operation of the pump assembly 44.

During the deceleration fuel cut-off event, the control-circuitry 38 may direct the fuel pump assembly 44 via command signal 54 to supply pressurized fuel to the accumulator 56 when needed. Such fuel recharging of the accumulator 56 during deceleration fuel cut-off events, enables taking advantage of alternator regeneration to electrically power the motor 44B of the fuel pump assembly 44. This accumulator architecture may reduce fuel pump electrical loads by about eighty-five percent (85%) or greater (e.g., 26 watts to 4 watts) that may be equivalent to a reduction of about 1.1 grams of carbon dioxide per mile.

In one embodiment, the solenoid valve 52 may receive control signal(s) (see arrow 68 in FIG. 1) from the control-circuitry 38 to limit filling, or recharging, of the accumulator 56 during engine startup (i.e., the solenoid valve 52 may be substantially closed). This permits all fuel expelled by the fuel pump 44A to be supplied to the fuel pump 26A at a time when substantial amounts of fuel are needed. In addition, the solenoid valve 52 may be directed to close at vehicle shut-down to preserve fuel pressure and volume in the accumulator 56. It is contemplated and understood that the solenoid valve 52 may be biased closed by, for example, a spring, and the control-circuitry 38 effects energizing of the solenoid to open the valve, or vice versa.

In another embodiment, the solenoid valve 52 may be a pressure limiting valve that opens to recharge or fill the accumulator 56 only when the pump assembly 44 is controlled to higher pressures. During pump control at moderate pressures the valve 52 is closed thus allowing all fuel, pumped by the pump 44A, to flow to the engine 21 (e.g., fast fuel feed priming at engine startup).

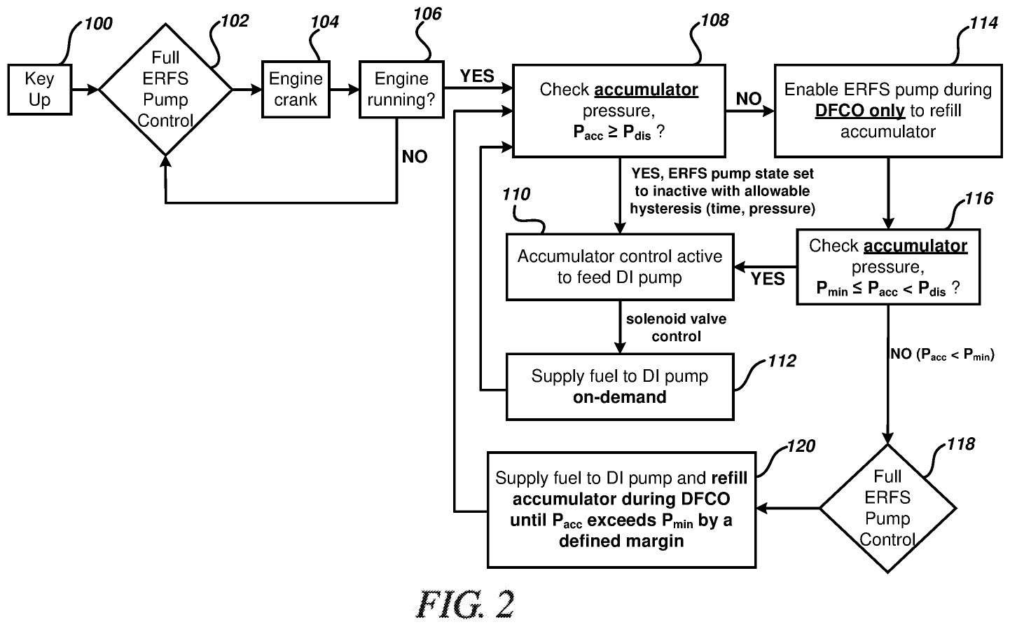

Referring to FIG. 2, one, non-limiting, method of operating the fuel system 20 is illustrated. At block 100, the vehicle may be keyed-up (i.e., ignition turned on) to start engine. Before, during, and immediately after key-up, the solenoid valve 52 may be closed. At block 102, full control of the pump assembly 44 is established. At block 104, the engine 21 is cranking, the pump assembly 44 is outputting fuel at a prescribed pressure to the pump assembly 26, and the solenoid valve 52 remains closed. At block 106, the control-circuitry 38, via sensory input (see arrow 70 in FIG. 1), determines if the engine 21 is running. If the engine 21 is not running, the control logic returns to block 102.

If the engine 21 is running and at block 108, the control-circuitry 38 determines if a measured accumulator fuel pressure (P_{acc}) (see arrow 76), received from a pressure sensor 74 adapted to measure fuel pressure in the accumulator 56, is greater than, or equal to, a preprogrammed minimum accumulator discharge pressure (Pais). In one embodiment, the P_{d}is may be, or may be equivalent to, the specified feed fuel pressure (i.e., data file 66). It is contemplated and understood that the accumulator 56 with the internal bladder 60 may be physically constructed to maintain a predetermined internal fuel pressure. As such, the pressure sensor 74 may not be required. Instead, solenoid valve 52 may open upon confirmation that the engine is running at block 106, and the feed pressure readings may be taken from pressure sensor 34. That is, P_{acc} is associated with the measured pressure signal 35 when the solenoid valve 52 is open and the pump assembly 44 is inactive.

If the P_{acc} is greater than, or equal to, the P_{dis}, and at block 110, the normally closed solenoid valve 52 may open upon receipt of the control signal 68 from the control-circuitry 38. With valve 52 open and at block 112, the pump assembly 44 is inactive and the accumulator 56 feeds fuel to the pump assembly 26 on a demand basis. This source of fuel continues (i.e., control loop continues) until the P_{acc} is less than the Pais.

From block 108, when the P_{acc} becomes less than P_{dis}, and at block 114, the pump assembly 44 is enabled by the signal 54 from the control-circuitry 38 during a deceleration fuel cut-off event to refill the accumulator 56. At block 116, the control-circuitry 38 determines if a preprogrammed minimum pressure (Pₘᵢₙ) is less than, or equal to, the P_{acc} which is less than the P_{dis}. If yes, the accumulator 56 remains as the source of fuel for the pump assembly 26. It is understood that Pₘᵢₙ is the predetermined minimum accumulator discharge pressure permitted to meet pump assembly 26 requirements. In contrast, the P_{dis} is the minimum accumulator discharge pressure permitted to meet pump assembly 26 requirements without assistance from pump assembly 44. P_{dis} may also be viewed as the maximum pressure capacity of the accumulator 56 where no further refill is possible.

If Pₘᵢₙ is not less than, or equal to, the P_{acc} and at block 118 the pump assembly 44 assumes full control and the solenoid valve 52 remains open. At block 120 and while the pump assembly 44 is under full control, the pump 44A supplies fuel to both the pump assembly 26 and to the accumulator 56 for recharge/refill, and until the P_{acc} exceeds the Pₘᵢₙ by a predefined margin (i.e., part of data file 66). Once the P_{acc} exceeds the Pₘᵢₙ, the control logic returns to block 108.

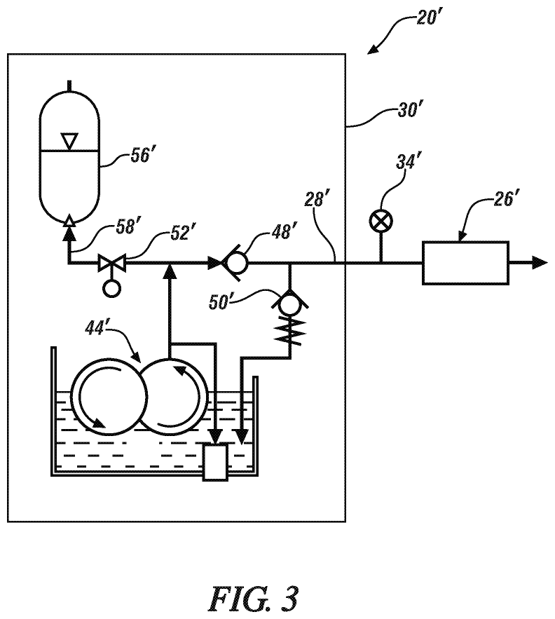

Referring to FIG. 3, a second embodiment of the fuel system is illustrated wherein like elements have like identifying numerals except with the addition of a prime suffix. A fuel system 20′ includes a fuel pump assembly 26′, a fuel line or conduit 28′, a pressure sensor 34′, a fuel pump assembly 44′, a check valve 48′, a pressure relief valve 50′, a solenoid valve 52′, and an accumulator 56′. The configuration and functioning of the various components of the fuel system 20′ is similar to that of fuel system 20, except that the check valve 48′ is in the conduit 28′. More specifically, the check valve 48′ is located between the solenoid valve 52′ and the pump assembly 26′. Moreover, the outlet of the pump assembly 44′ is adapted to deliver fuel to the conduit 28′, at a location between the solenoid valve 52′ and the check valve 48′.

Advantages and benefits of the present disclosure include a reduction in electrical load thus improvements in fuel economy and carbon dioxide emissions. Other benefits include a reduction in hot soak pressures that improves material durability, and an improvement in hot fuel handling performance.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A returnless fuel system comprising:
a fuel injector;
an accumulator adapted to store pressurized fuel that is utilized by the fuel injector during prescribed conditions;
a first fuel pump assembly adapted to supply the pressurized fuel at a first controlled pressure to the fuel injector; and
a second fuel pump assembly in fluid communication with the accumulator and in fluid communication with the first fuel pump assembly independently from the accumulator, and adapted to provide the pressurized fuel at a second controlled pressure to the first fuel pump assembly and the accumulator.

2. The returnless fuel system set forth in claim 1, further comprising:
at least one pressure sensor configured to measure accumulator fuel pressure (P_{acc}) upstream of the first fuel pump assembly and output a pressure signal;
one or more non-transitory storage mediums configured to store a data file including a preprogrammed minimum first accumulator discharge pressure (P_{dis}); and
one or more processors configured to receive the pressure signal and compare the measured accumulator fuel pressure (P_{acc}) to the preprogrammed minimum first accumulator discharge pressure (P_{dis}) and maintain the second fuel pump assembly in an inactive state while the accumulator provides the pressurized fuel to the first fuel pump assembly if the measured accumulator fuel pressure (P_{acc}) is greater than or equal to the preprogrammed first minimum accumulator discharge pressure (P_{dis}).

3. The returnless fuel system set forth in claim 2, further comprising: a check valve located downstream of the second fuel pump assembly.

4. The returnless fuel system set forth in claim 3, further comprising:
a solenoid valve adapted to isolate the accumulator from the check valve and the first fuel pump assembly during at least one of start-up and shut-down conditions.

5. The returnless fuel system set forth in claim 4, wherein the one or more processors are configured to effect opening of the solenoid valve and activate the second fuel pump assembly to provide fuel to the accumulator during a deceleration fuel cut-off event and when the measured accumulator fuel pressure (P_{acc}) is not greater than or equal to the preprogrammed first minimum accumulator discharge pressure (P_{dis}).

6. The returnless fuel system set forth in claim 2, wherein the one or more processors are configured to activate the second fuel pump assembly to at least provide fuel to the accumulator during a deceleration fuel cut-off event and when the measured accumulator fuel pressure (P_{acc}) is less than the preprogrammed first minimum accumulator discharge pressure (P_{dis}).

7. The returnless fuel system set forth in claim 6, wherein the one or more processors are configured to deactivate the second fuel pump assembly when a preprogrammed second minimum accumulator discharge pressure (Pₘᵢₙ) stored in the data file is less than or equal to the measured accumulator fuel pressure (P_{acc}) and the measured accumulator fuel pressure (P_{acc}) is less than the preprogrammed first minimum accumulator discharge pressure (P_{dis}).

8. The returnless fuel system set forth in claim 7, wherein the one or more processors are configured to effect activation of the second fuel pump assembly during the deceleration fuel cut-off event for supplying fuel to both the accumulator and the second fuel pump assembly when the measured accumulator fuel pressure (P_{acc}) is less than the preprogrammed second minimum accumulator discharge pressure (Pₘᵢₙ).

9. The returnless fuel system set forth in claim 8, wherein the one or more processors are configured to effect deactivation of the second fuel pump assembly during the deceleration fuel cut-off event when the measured accumulator fuel pressure (P_{acc}) exceeds the preprogrammed second minimum accumulator discharge pressure (Pₘᵢₙ) by a preprogrammed margin stored in the data file.

10. The returnless fuel system set forth in claim 6, wherein the one or more processors activate the second fuel pump assembly by facilitating the receipt of electrical power produced from alternator regeneration to the second fuel pump assembly and during the deceleration fuel cut-off event.

11. The returnless fuel system set forth in claim 1, further comprising:
a fuel conduit adapted to provide fluid communication between the first fuel pump assembly, the second fuel pump assembly, and the accumulator;
a solenoid valve adapted to isolate the accumulator from the fuel conduit;
a fuel pressure relief valve; and
a fuel tank, wherein the accumulator is in the fuel tank, and the fuel pressure relief valve is adapted to flow fuel from the fuel conduit to the fuel tank during over fuel pressure conditions in the fuel conduit.

12. The returnless fuel system set forth in claim 11, wherein the second fuel pump assembly is in the fuel tank.

13. (canceled)

14. A returnless fuel system comprising:
a fuel injector;
an accumulator adapted to store pressurized fuel that is utilized by the fuel injector during prescribed conditions;
a first fuel pump assembly adapted to supply the pressurized fuel at a first controlled pressure to the fuel injector;
a second fuel pump assembly in fluid communication with the accumulator and the first fuel pump assembly, and adapted to provide the pressurized fuel at a second controlled pressure to the first fuel pump assembly and the accumulator;
a solenoid valve adapted to isolate the accumulator during at least one of start-up and shut-down conditions;
a fuel conduit in communication with and extending between the first and second fuel pump assemblies;
a check valve adapted to prevent the backflow of pressurized fuel from the fuel conduit and through the second fuel pump assembly;
a fuel tank; and
a fuel pressure relief valve adapted to flow fuel from the fuel conduit to the fuel tank during over fuel pressure conditions in the fuel conduit.

15. A method of operating a fuel system comprising:
flowing fuel from a hydraulic accumulator to a direct injection (DI) fuel pump assembly;
pumping by the DI fuel pump assembly to at least one fuel injector for combustion in a combustion engine; and
recharging the hydraulic accumulator by an electric fuel feed pump assembly, wherein the electric fuel feed pump assembly is configured to recharge the hydraulic accumulator during deceleration fuel cut-off events.

16. (canceled)

17. The method set forth in claim 15, further comprising:
opening a normally closed solenoid valve located proximate to an opening of the hydraulic accumulator when the hydraulic accumulator is flowing the fuel to the DI fuel pump assembly, and when the electric fuel feed pump assembly is recharging the hydraulic accumulator.

18. The method set forth in claim 17, wherein the hydraulic accumulator and the electric fuel feed pump assembly are located in a fuel tank of the fuel system.

19. The returnless fuel system set forth in claim 14, wherein the check valve is in direct fluid communication with the solenoid valve and the fuel pressure relief valve via the fuel conduit.
